(19) United States
(12) Patent Application Publication
(10) Pub. No.: US 2007/0292591 A1
(43) Pub. Date: Dec. 20, 2007

(54) BEAN CURD AND MANUFACTURING METHOD THEREOF

(76) Inventor: SUNG YONG HWA, JINJU CITY KYUNGNAM (KR)

Correspondence Address: IPLA P.A., 3580 WILSHIRE BLVD., 17TH FLOOR, LOS ANGELES, CA, 90010, US

(21) Appl. No.: 11/765,733

(22) Filed: Jun. 20, 2007

(30) Foreign Application Priority Data
Jun. 20, 2006 (KR) 10-2006-0055336

(51) Int. Cl. A23L 1/20

(52) U.S. Cl. 426/634

(57) ABSTRACT

Disclosed herein are a bean curd and a manufacturing method thereof. The method comprises washing and immersing soy beans in water; mixing the soy beans with clean water, grinding the soy beans and removing dregs to produce a bean paste; simmering the bean paste; straining soymilk from the bean paste; coagulating the soymilk with a natural coagulant comprising Japanese apricot vinegar, apple vinegar and ENA mineral A to afford a silken bean curd; and pressing the silken bean curd in a mold. The bean curd can be stored for a long period of time, and that can provide beneficial minerals, and a manufacturing method thereof.

### CROSS REFERENCE

This application claims foreign priority under Paris Convention and 35 U.S.C. §119 to Korean Patent Application No. 10-2006-0055336, filed Jun. 20, 2006 with the Korean Intellectual Property Office.

### BACKGROUND OF THE INVENTION

1. Field of the Invention

The present invention relates, in general, to bean curd and a manufacturing method thereof and, more particularly, to functional bean curd supplemented with mineral ingredients and vitamins and a method for manufacturing the same.

2. Description of the Related Art

Bean curd, also called tofu, has been reported to have various healthy functions including reduction in blood cholesterol level, prevention of osteoporosis, potentiation of renal function, and suppression of arteriosclerosis. Generally, bean curd is rich in isoflavones, out of which genistein is known to serve as an anti-cancer agent, working through its antioxidant activity and as a female hormone.

Tofu is made by soaking beans in water, grinding them along with the dregs drained therefrom, boiling the soy milk and pressing the resulting curds before packaging and storing.

Coagulation is the most important step in the production of tofu because it has the greatest influence on the textural property of the bean curd. This process is accomplished with the aid of coagulants and is thus completely dependent on the type and amount thereof.

Brine has been conventionally used as a coagulant, but the use thereof is restricted by law due to marine pollution. Coagulants that are now typically used include calcium sulfate (CaSO₄), magnesium chloride (MgCl₂), and glucono delta lactone (G.D.L.).

Currently, coagulation is based on two types of coagulants: inorganic salts and organic acids. Calcium sulfate, calcium chloride and magnesium chloride typify inorganic salt coagulants. When these salts are added to soy milk, there occurs the substitution of cations, such as Ca²⁺, Mg², etc., for the H of carboxyl group of glycine (NH₂CH₂COOH). The free H⁺ ions function to promote dehydration between the amino group and the carboxyl group, thus forming a precipitate of macro-peptide molecules. Alternatively, the groups, —N— and C═O, which can form coordination bonds, are chelated with Ca²⁺ such that colloidal proteins precipitate. Calcium sulfate is feasible to use and is an effective coagulant because it is slowly dissolved and reacts with high specificity owing to the very low solubility thereof. In sharp contrast, only a low yield can be obtained using calcium chloride, because its high solubility causes a swift reaction. Magnesium chloride produces softer precipitates at a higher yield than calcium chloride. When ingested in a lipid-soluble condition, inorganic salts are unlikely to come out of the body, but accumulate therein, causing adult diseases.

Representative of the coagulants of organic acids is δ-gluconic lactone (glucono delta lactone, G.D.L.). In water, δ-gluconic lactone is dissolved into gluconic acid, decreasing the pH to the isoelectronic point (pH4.2˜4.6), at which curdling occurs, due to the loss of solubility. Coagulation using organic acids has an advantage over that using inorganic salts in terms of yield and texture, but suffers from a disadvantage in that the resultant bean curd is a little sour.

Bean curd, once produced, must be consumed within a very short period of time because it is apt to putrefy due to its high water content, which exceeds 80%, and the presence of microorganisms originally present in the beans. Although it is higher in calcium content than other protein foods, the bean curd manufactured with inorganic salts shows only low bioavailability of calcium, because calcium sulfate has a low dissolution constant.

Conventional bean curd is rich in protein, but poor in preservability as well as problematic in containing mineral ingredients in association with lipids.

Leading to the present invention, thorough and intensive research into bean curd, conducted by the present inventors, resulted in the finding that a new natural coagulant and additives provide bean curds with abundant minerals and vitamins.

Conventional bean curds are inconvenient to eat because they must be boiled in water or fried in oil in order to dissolve the inorganic coagulant.

### SUMMARY OF THE INVENTION

Accordingly, the present invention has been made keeping in mind the above problems occurring in the prior art, and an object of the present invention is to provide a functional bean curd that can be preserved for a prolonged period of time and is rich in proteins and beneficial minerals, and a method of manufacturing the same.

In accordance with an aspect of the present invention, there is provided a method for manufacturing a functional bean curd, comprising: washing and immersing soy beans in water; mixing the soy beans with clean water, grinding the soy beans and removing dregs to produce a bean paste; simmering the bean paste; straining soymilk from the bean paste; coagulating the soymilk with a natural coagulant, comprising Japanese apricot vinegar, apple vinegar and ENA mineral A, to afford a silken bean curd; and pressing the silken bean curd in a mold.

In a preferable embodiment of this aspect, one selected from a group consisting of a deer antler extract, a ginseng extract, a chitosan material, and a combination thereof is added in an amount of 0.1˜0.5 parts by weight, based on 100 parts by weight of the bean paste.

In another preferable embodiment of this aspect, the natural coagulant is a mixture comprising the Japanese apricot vinegar, the apple vinegar and ENA mineral A in a volume ratio of 20:20:1, respectively.

The ENA mineral A (disclosed in Korean Patent 471684) contains red algae and cuttlebones and, optionally, other processed foods.

In accordance with another aspect of the present invention, there is provided bean curd manufactured by mixing the soy beans with clean water, grinding the soy beans, removing dregs to produce a bean paste, simmering the bean paste, straining soymilk from the bean paste; coagulating the soymilk with a natural coagulant comprising Japanese apricot vinegar, apple vinegar and ENA mineral A to afford a silken bean curd, and pressing the silken bean curd in a mold.

In a preferable embodiment of this aspect, one selected from a group consisting of a deer antler extract, a ginseng extract, a chitosan material, and a combination thereof is added in an amount of 0.1˜0.5 parts by weight based on 100 parts by weight of the bean paste.

In another preferable embodiment of this aspect, the natural coagulant is a mixture comprising the Japanese apricot vinegar, the apple vinegar and ENA mineral A in a volume ratio of 20:20:1, respectively.

In a modification, the ENA mineral A comprises one selected from a group consisting of vinegar made from fruits of Schisandra chinensis, persimmon vinegar, a deer antler extract, a ginseng extract, chitosan, chlorella and a combination thereof.

In accordance with a further aspect of the present invention, there is provided a natural coagulant for use in manufacturing bean curds, comprising Japanese apricot vinegar, apple vinegar and ENA mineral A.

In a preferable embodiment of this aspect, the natural coagulant is a mixture comprising the Japanese apricot vinegar, the apple vinegar and ENA mineral A in a volume ratio of 20:20:1, respectively.

### BRIEF DESCRIPTION OF THE DRAWING

FIG. 1 is a flow chart illustrating the processes of manufacturing the bean curd according to the present invention.

### DESCRIPTION OF THE PREFERRED EMBODIMENTS

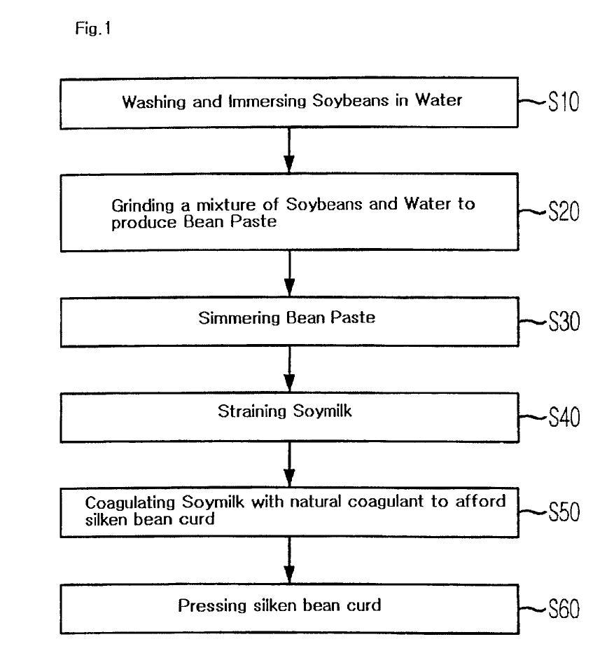

With reference to FIG. 1, a detailed description will be given of a method for manufacturing bean curd according to the present invention.

First, soya beans are washed with and soaked in water (S10). They are allowed to swell for a predetermined period of time.

Next, the soya beans in admixture with clean water are ground with a mixer, followed by removing dregs to produce bean paste. In this regard, 3.5 kg of soy beans is added to 40 liters of clean water and ground to produce bean paste.

Optionally, the bean paste may be supplemented with a deer antler extract, a ginseng extract and/or a chitosan material. Based on 100 parts by weight of the soy beans used, the bean paste may be preferably mixed with 0.1-0.5 parts by weight of a deer antler extract, 0.1-0.5 parts by weight of a ginseng extract, and/or 0.1-10 parts by weight of a chitosan material. The chitosan material may be a mixture of chitosan and minerals or a molecular weight-modified chitosan.

Chitosan, now recognized as a health aid food, is derived through deacetylation from chitin, which is an abundant biopolymer found in the shells of crustaceans, particularly lobsters and crabs. Chitosan finds useful applications in a variety of fields, including fibers, paper, medicines, foods, cosmetics, waste water treatment, etc. In addition, chitosan is known to promote the proliferation of useful intestinal bacteria, such as Bifidus spp. and lactic acid bacteria as well as showing potent anti-bacterial activity against harmful bacteria. Also, chitosan has an antihypertensive effect as it captures chloride ions, originating from salt contained in ingested food, and excretes the ions with feces, to thereby exhibit an action of reducing blood pressure. This is because chloride ions in the blood activate an enzyme which acts to elevate blood pressure. Further, the reduction in the blood level of chloride ions due to chitosan helps suppress the over-secretion of insulin, resulting in the mitigation of the blood pressure increase attributed to obesity. Moreover, chitosan serves as a preservative to prolong the freshness of freshly made bean curd. When added to bean curd, chitosan thus functions to preserve the bean curd for a long period of time, and imparts an antihypertensive property to the bean curd thanks to the ability to excrete chloride ions.

Subsequently, the bean paste, supplemented optionally with a deer antler extract, a ginseng extract and/or a chitosan material, is left to simmer on heat (S30). Preferably, the simmering is conducted at 115° C. for 20 min.

Afterward, soymilk is obtained from the heated bean paste (S40).

Then, the soymilk is coagulated with a natural coagulant, comprising Japanese apricot vinegar, apple vinegar and ENA mineral A, to prepare silken bean curd. The natural coagulant preferably comprises a volume mixture of 20:20:1 Japanese apricot vinegar:apple vinegar:ENA mineral A. Following the addition of the natural coagulant, the soymilk is preferably allowed to stand for 10˜20 min. The silken bean curd may be stirred and consumed as a drink.

A Japanese apricot can be used as an alkaline food which is abundant in organic acids, such as citric acid and malic acid, various vitamins, and alkaline elements, such as calcium and potassium, and is known to have various functions including antioxidative activity, anticancer activity, antibacterial activity, invigorating activity, and alcohol metabolism enhancement.

Apples contain a lot of glucides such as fructose, glucose, etc., organic acids, and minerals such as potassium. Pectin, found abundantly in apples, aids the proliferation of beneficial intestinal bacteria, such as lactic acid bacteria, to thereby promote digestion.

ENA mineral A is a food containing natural minerals extracted from red algae and cuttlebone. Among red algae are lithothamnium calcareum gelidiales, gigartinales, rhodymeniales, ceramiales, and cryptonemiales. Having a porous structure, natural calcium from these marine algae is applicable to various foods and exhibits much higher bioavailability than calcium carbonate.

For the coagulation of soymilk, ENA mineral A serves as mineral salts while Japanese apricot vinegar and apple vinegar serve as organic acids.

Finally, when large white curds can be seen, they are ready to be filtered through a clean cloth into a suitable mold and strained out (S60). The cloth lined bean curds are pressed with a weight of 20 g/cm² for about 10 min to form a block of bean curds according to the present invention.

The bean curds prepared according to the present invention were analyzed for ingredients and tested, and the results are summarized in Tables 1 and 2, respectively. As seen in Table 1, the bean curd according to the present invention is rich in proteins as well as various minerals that are beneficial to the health of the body. Also, the bean curds with the natural vitamins were subjected to a sensory test with a panel of 20 people. As a result of the sensory test, the functional bean curds were determined to taste pure with a savory and refreshed aftertaste.

TABLE 1
Ingredients of the Functional Bean Curd

| Ingredients | Contents | Units |
|---|---|---|
| | 6.625 | mg/100 g |
| Ca | 438.9 | mg/100 g |
| Zn | 1.245 | mg/100 g |
| Mg | 139.6 | mg/100 g |
| Na | 7.274 | mg/100 g |
| K | 2.726 | mg/100 g |
| Cu | 1.175 | mg/100 g |
| Mn | 0.339 | mg/100 g |
| I | 4.469 | mg/100 g |
| Crude Protein | 0.343 | % |
| Vitamin C | 6.021 | mg/100 g |
| Niacinamide | Not detected | mg/100 g |

TABLE 2
Test Results of the Functional Bean Curds

| Tests | Standards | Results | Units |
|---|---|---|---|
| Property | Characteristic color tone, no nasty | Suitable | |
| | taste and smell | | |
| Solid Content | 12 or more for firm bean curd | 12 | % |
| | 6 or more for silken bean curd (10 or | | |
| | more for packaged bean curd) | | |
| Heavy metals | 3.0 or less | Not | mg/kg |
| | | detected | |
| Crude proteins | 40 or more for firm bean curd, | 48 | % |
| | 36 or more for silken curd | | |

Also, the bean curds according to the present invention were subjected to sensory tests and analyzed for change in bacteria count, volatile basic nitrogen, pH and acidity against time, and the results are summarized in Tables 3 to 7.

First, Table 3 shows the results of the sensory test with the bean curds according to the present invention. The sensory test examined the appearance, texture, smell, color tone, and general acceptability, for each of which a scoring method was employed on a scale from 1 to 9. A higher score represented a better quality, with a quality limit value of 5.

The sensory test was repeated four times using a randomized block design. Data were analyzed using analysis of variance and a least significant difference test conducted to ascertain whether the analysis of variance results were significant.

TABLE 3
Results of Sensory Test for the Bean Curds

| Days post- | | | | | General |
|---|---|---|---|---|---|
| manufacture | Appearance | Texture | Smell | Color tone | Acceptability |
| Zero | 8 | 9 | 9 | 9 | 9 |
| 6th day | 7 | 8 | 8 | 8 | 8 |
| 10th day | 7 | 7 | 7 | 8 | 7 |
| 15th day | 6 | 6 | 5 | 6 | 6 |
| 20th day | 4 | 4 | 4 | 5 | 4 |

9 very good,
8 good,
5 moderate,
3 poor,
1 very poor

When kept cold (0˜10° C.), as seen in Table 3, the bean curds according to the present invention were determined to remain good in appearance, texture, smell, color tone and general acceptability for up to 15 days of storage, with the scores acquired as high as or higher than the quality limit value of 5. On the 20^{th} day after manufacture, the bean curds scored 4 on most test items.

From a sensory aspect, therefore, the maximum possible storage period of time for the bean curd according to the present invention is determined to be 15 days after the manufacture thereof, given that it is refrigerated.

In Table 4, the counts of bacteria found in the bean curds according to the present invention are recorded depending on time after manufacture, during which they are kept cold (0˜10° C.). Bacteria were counted according to a microorganism assay method of the Food Protocol.

TABLE 4
Cell counts of the Bean Curds

| Days Post-manufacture | Cell Counts (CFU/g) |
|---|---|
| Zero | 1.2 × 104 |
| 6th Day | 4.8 × 104 |
| 10th Day | 7.2 × 104 |
| 15th Day | 9.8 × 104 |
| 20th Day | 1.7 × 105 |

The bean curds were increased in cell count from 1.2×10⁴ CFU/g over time spent in storage.

In the aspect of cell count, the maximum possible storage period of time for the bean curd according to the present invention was determined to be 15 days from the manufacture thereof, as long as it is refrigerated.

In Table 5 are recorded the results of a test for the content of volatile basic nitrogen (VBN) in the bean curds of the present invention depending on time after manufacture, during which they are kept cold (0˜10° C.). The initial content of VBN was measured at 9.98 mg %, and remained unchanged for the storage time. The test was conducted according to the VBN method of the Food Protocol.

TABLE 5
Volatile Basic Nitrogen Contents of the Bean Curds

| Days Post-manufacture | VBN (mg/%) |
|---|---|
| Zero | 9.980 |
| 6^{th} Day | 10.008 |
| 10^{th} Day | 10.036 |
| 15^{th} Day | 10.019 |
| 20^{th} Day | 10.049 |

In Table 6 are recorded the results of a test for the pH of the bean curds of the present invention depending on time after manufacture, during which they are kept cold (0˜10° C.). The pH of the bean curds was measured using a pH meter. The initial pH was measured to be 6.2, and no significant changes were detected over 15 days, during which the bean curds remained good from a sensory aspect.

TABLE 6
pH of the Bean Curds

| Days Post-manufacture | pH |
|---|---|
| Zero | 6.2 |
| 6^{th} Day | 6.3 |
| 10^{th} Day | 6.4 |
| 15^{th} Day | 6.4 |
| 20^{th} Day | 6.3 |

Table 7 summarizes the results of testing for the change of the bean curds in acidity. No significant changes from the initially measured acidity of 0.025% were detected over 15 days, during which the bean curds remained good from a sensory aspect.

TABLE 7
Acidity of the Bean Curds

| Days Post-manufacture | Acidity (%) |
|---|---|
| Zero | 0.025 |
| 6^{th} Day | 0.035 |
| 10^{th} Day | 0.035 |
| 15^{th} Day | 0.036 |
| 20^{th} Day | 0.032 |

Therefore, the bean curds can be stored for up to 15 days when refrigerated, in the aspect of sensory test and cell count. It is however preferred that the storage period of time for the bean curds according to the present invention be set within 12 days after the manufacture thereof when refrigerated, in consideration of safety in practice.

When it is manufactured by the method of the present invention, conducted by grinding soy beans with clean water, simmering a bean paste free of dregs on heat, straining soymilk from the bean paste, coagulating the soymilk with the aid of a natural coagulant comprising Japanese apricot vinegar, apple vinegar and ENA mineral A to produce silken bean curds, and pressing the silken bean curds in a mold, the firm bean curds can be lengthened in storage period as well as providing beneficial minerals.

Although it has been described as containing both red algae and cuttlebone, ENA mineral A may comprise only one of the two.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

As described above, the present invention provides bean curds that can be stored for a longer period of time than conventional bean curd, and that can provide beneficial minerals, and a manufacturing method thereof.

What is claimed is:

1. A method of manufacturing a functional bean curd, comprising:
washing and immersing soy beans in water;
mixing the soy beans with clean water, grinding the soy beans and removing dregs to produce a bean paste;
simmering the bean paste;
straining soymilk from the bean paste;
coagulating the soymilk with a natural coagulant comprising Japanese apricot vinegar, apple vinegar and ENA mineral A to afford a silken bean curd; and
pressing the silken bean curd in a mold.

2. The method according to claim 1, wherein the natural coagulant is a mixture comprising the Japanese apricot vinegar, the apple vinegar and ENA mineral A in a volume ratio of 20:20:1, respectively.

3. The method according to claim 2, wherein the ENA mineral A comprises one selected from a group consisting of vinegar made from fruits of Schisandra chinensis, persimmon vinegar, a deer antler extract, a ginseng extract, chitosan, and a combination thereof.

4. The method according to claim 1, wherein the bean paste is produced from a mixture ratio of 3.5 kg soybeans and 40 liters clean water.

5. The method according to claim 1, further comprising adding a material selected from a group consisting of a deer antler extract, a ginseng extract, a chitosan material and a combination thereof to the bean paste before the simmering step.

6. The method according to claim 5, wherein the natural coagulant is a mixture comprising the Japanese apricot vinegar, the apple vinegar and ENA mineral A in a volume ratio of 20:20:1, respectively.

7. The method according to claim 6, wherein the ENA mineral A comprises one selected from a group consisting of vinegar made from fruits of Schisandra chinensis, persimmon vinegar, a deer antler extract, a ginseng extract, chitosan, and a combination thereof.
